(19) United States
(12) Patent Application Publication
(10) Pub. No.: US 2020/0058416 A1
(43) Pub. Date: Feb. 20, 2020

(54) Electrical Insulation System Based on Epoxy Resins for Generators and Motors

(71) Applicants: Huntsman Advanced Materials Licensing (Switzerland) GmbH, The Woodlands, TX (US); ISOVOLTA AG, Wiener Neudorf (AT)

(72) Inventors: Christian Beisele, Müllheim (DE); Daniel Baer, Riehen (CH); Harald Stecher, Skoerping (DK); Melanie Brasch, Pirka (AT)

(21) Appl. No.: 16/346,547

(22) PCT Filed: Oct. 20, 2017
(86) PCT No.: PCT/EP2017/076838

§ 371 Date: May 1, 2019

(30) Foreign Application Priority Data
Nov. 1, 2016 (EP) 16196684.1

(51) Int. Cl. H01B 3/04; C08L 63/00; C08G 59/24; C08G 59/50; H01B 17/60

(52) U.S. Cl. CPC H01B 3/04; C08L 63/00; H01B 7/02; C08G 59/5073; H01B 17/60; C08G 59/245

(57) ABSTRACT

Disclosed is an anhydride-free insulation system for insulating an electrical conductor or a coil of conductors, comprising:
(a) a liquid epoxy resin formulation comprising at least 80% by weight, based on the liquid epoxy resin bath formulation, of bisphenol A diglycidyl ether,
(b) a mica tape comprising a mica paper adhered by means of a binder to a support
(c) an imidazole compound of the formula (I)

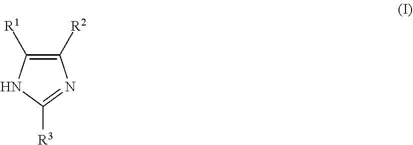

wherein R¹, R² and R³ are individually selected from hydrogen, branched or unbranched C₁-C₄-alkyl, phenyl and benzyl, provided that at least one of R¹ and R² is hydrogen.

### FIELD OF THE INVENTION

The present invention relates to a novel electrical insulation system for vacuum pressure impregnation of electrical machines, in particular large electrical machines, which insulation system is based on a thermally curable liquid epoxy resin formulation. The invention further relates to the use of said insulation system in the insulation of conductors or coils of conductors of electrical machines and to processes for producing an insulated electrical machine comprising an electrical conductor or a coil comprising electrical conductors.

### BACKGROUND

Electrical engines, such as generators used for power plants or large electrical motors, contain current-carrying parts, e.g. wires and/or coils, that need to be electrically insulated against each other and/or against other electroconductive parts of the engine with which they would otherwise have direct contact. In medium or high voltage engines this insulation is typically provided by mica paper or mica tapes. After wrapping its current-carrying parts with the mica tape, either the whole equipment or only a part thereof is impregnated with a curable liquid resin formulation which also penetrates the mica tape. The impregnated resin is then cured to provide a solid insulation. This impregnation can advantageously be carried out using the well-know vacuum pressure impregnation (VPI) process.

The viscosity of the VPI impregnation resin must be low, and must remain low, at the VPI impregnation temperature. The lower the viscosity of the formulation is, the better and faster it can fill up gaps and voids in the component and mica tape to be impregnated. The more the viscosity of the impregnation remains low, the more VPI cycles can be run with an impregnation bath without needing to replace it completely; only the amount of impregnation bath actually used up during each VPI cycle needs to be replaced. This VPI impregnation temperature is commonly above room temperature, which reduces the viscosity of the impregnation bath.

The currently most widely used resin formulation for VPI insulation of electrical components are epoxy resins based on diglycidyl ethers of bisphenol A and/or bisphenol F, optionally in combination with cycloaliphatic epoxy resins, which further lower the viscosity of the formulation.

VPI impregnation epoxy resins have been customarily cured with co-use of anhydrides, such as methylhexahydrophthalic acid anhydride (MHHPA) or hexahydrophthalic acid anhydride (HHPA) as curing agent (hardener). The anhydride hardener is customarily admixed homogeneously to the impregnation resin formulation and also further lowers its viscosity. Anhydrides customarily used as such hardeners have now however been assigned under the REACH regulation an R42 label as respiratory sensitizers, and their use in the future is uncertain.

The reactivity of the impregnation formulation should preferably increase at temperatures higher than the said VPI impregnation temperature in order to ensure a fast curing of the formulation after the VPI impregnation. In order to achieve this a latent curing catalyst, also called an accelerator, is commonly used with the resin. The term “latent” means that the accelerator is essentially inactive at temperatures up to the VPI impregnation temperature, but will catalyse the curing at higher temperatures. In the VPI impregnation process the accelerator is often not included into the impregnating bath, but into the mica tape. This further slows down the increase in viscosity of the impregnation bath over time, because no or only marginal residual amounts of accelerator are present in the bulk of the impregnation bath.

The mica tape used in the VPI process is commonly a muscovite or phlogopite mica paper in which the mica particles are adhered by a binder, such as an epoxy resist, to a mechanically strenghtening support, such as in particular a glass cloth.

An important parameter of a cured VPI insulation material is its dielectric dissipation factor tan δ under AC current, which corresponds at low 8 values to the fraction of AC power applied that is lost in the insulation material. It is therefore frequently expressed as a percentage, for example a tan δ of 0.1 corresponds to 10% power loss. The dissipation factor depends on the permittivity of the insulating material and on several processing parameters, such as the degree of cure of the insulating material, its content of voids, moisture and impurities etc., and can thus only be determined on the finished insulation material. An insulation should preferably have a tan δ of less than about 10%.

The above mentioned dissipated AC power is converted to waste heat, which, together with the heat from Eddy currents, causes electrical parts and insulation to be heated up. The heating up in turn generally brings about an increase of the dissipation factor of the insulation, thus still further increasing the power loss by dissipation and thus the heating up. The insulation may deteriorate upon such prolonged and pronounced heating. A particularly important descriptor of an insulation is thus its “thermal class”, which is the maximum allowed 8 continuous working temperature for 20 years of working life. “Class F” and “Class H” insulations e.g. permit a maximum continuous use temperature of 155° C. and 180° C., respectively.

Imidazoles, in particular 2-ethyl-4-methyl imidazole, as such have been known as accelerators in homogeneous mixture for homopolymerisation of epoxies, such as of bisphenol-A-diglycidyl ether. Reference is made by way of example to Journal of Polymer Science 33, pp. 1843-1848 (1987).

US 2007/252449 A [corresponds to EP 1 850 460 B1 cited in the Invention Record] discloses a mica tape containing an oligomeric reaction product of imidazole with bis(glycidylether) of bisphenol A of formula (I) as accelerator and epoxy resin as the binder. The tapes were tested only for curing of impregnation resins containing bisphenol A epoxy resin and methylhexahydrophthalic anhydride 1:1.

JP 56/094614 A discloses a mica tape containing a lining material (a support), on the one side thereof a mica paper bound thereto and on the other side thereof an epoxy setting accelerator of imidazole.

JP 11/215753 A discloses a mica tape containing a mica paper, a reinforcing member, and an accelerator, such as an imidazole series accelerator, e.g. 2-methylimidazole, 2-ethyl-4-methylimidazole, 2-phenylimidazole, 1-benzyl-2-methylimidazole, 1-benzyl-2-ethyl-imidazole, 1-cyanoethyl-2-methylimidazole, 1-cyanoethyl-2-ethyl-4-methylimidazole, 1-methyl-2-ethylimidazole or 1-isobutyl-2-methylimidazole, or 2-ethyl-4-methyl-imidazolium tetraphenyl borate. This publications mentions the use of mica tapes in the curing of epoxy resins containing anhydride.

There is still a need for an insulation system suitable in particular for vacuum pressure impregnation using a mica tape, the insulation system containing an accelerator for epoxy resin curing, but where the impregnation resin is anhydride-free; wherein the insulation system has good processing characteristics comparable to those of the above described current “gold standard”-systems for vacuum pressure impregnation based on liquid epoxy resins and anhydride hardeners in particular in respect of impregnation effectiveness, curing speed, sufficiently low dielectric dissipation factor at all working temperatures permissible for Class F or possibly even Class H insulation systems.

### SUMMARY OF THE INVENTION

It has now been found that the afore-mentioned objective is solved by anhydride-free insulation system suitable for VPI-insulation of an electric machine comprising an electrical conductor or a coil of electrical conductors, which insulation system comprises:
(a) an amount mₑₚₒₓ (in grams) of a liquid epoxy resin formulation comprising at least 80% by weight, based on the liquid epoxy resin bath formulation, of bisphenol A diglycidyl ether,
(b) a mica tape comprising a mica paper adhered by means of a binder to a support, said mica tape having an area A the mica tape being suitable for wrapping around said conductor or around said coil, and, when wrapped around said conductor or around said coil, being impregnable by at least a part of said amount mₑₚₒₓ of said liquid epoxy resin formulation; and
(c) an amount m_{acc} (in grams) of an imidazole compound of the formula (I)

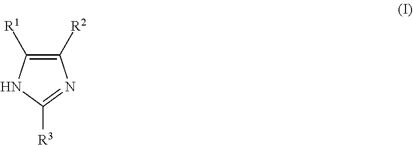

wherein R¹, R² and R³ are individually selected from hydrogen, branched or unbranched C₁-C₄-alkyl, phenyl and benzyl, provided that at least one of R¹ and R² is hydrogen;
or of an acid addition salt thereof, said imidazole of formula (I) or salt thereof being capable to act as a latent curing accelerator for the liquid epoxy resin formulation; the amount m_{acc} being either in the range

0.02mₑₚₒₓ≤m_{acc}≤0.10mₑₚₒₓ
or the range

$$A \times \frac{2 g}{{m}^{2}} \leq {m}_{acc} \leq A \times \frac{10 g}{{m}^{2}} ;$$

wherein all symbols are as defined above, and A is in square metres and m_{acc} is in grams;
   which insulation system is substantially or, preferably, entirely free of other latent epoxy curing accelerators not conforming to formula (I).

### DETAILED DESCRIPTION

It has been surprisingly found that liquid epoxy resin formulations comprising mainly diglycidyl ether of bisphenol A can be cured in the absence of any anhydrides in a VPI process using a mica tape by an imidazole-type accelerator of formula (I) or a salt thereof. It was furthermore surprisingly found that addition of small amounts (up to 5% by weight, based on the overall VPI impregnation resin containing the diglycidyl ether of bisphenol A) of cycloaliphatic epoxies gives, or addition of small amounts of diglycidyl ethers of bisphenol F (up to 10% by weight) are possible, maintaining a low tan δ value after curing of the VPI resin.

In formula (I), the numbering of the ring atoms starts with the hydrogen-bearing nitrogen and runs counterclockwise. The imidazole nucleus is tautomeric; the hydrogen may shift from the nitrogen shown in formula (I) to the other nitrogen. In this other tautomer, the residues R¹ and R² and their associated definitions must simply be swapped in order to obtain again the tautomer shown in above formula (I). In the following the imidazole compound is only discussed with reference to the tautomer shown in above formula (I), but the other tautomer shall be considered as encompassed.

In formula (I) preferably R¹ is hydrogen and R² is branched or unbranched Preferably, the combination of R¹, R² and R³ is such that the resulting imidazole compound has a melting point of at least 40° C. and below the minimum curing temperature chosen for curing the VPI resin, which is typically 120° C. or more. More preferably, the combination of R¹, R² and R³ is such that the resulting imidazole compound has a melting point in the range of 40° C. to 160° C. Still more preferably R¹ is hydrogen, R² is selected from the group consisting of hydrogen and methyl, and R³ is unbranched C¹-C⁴-alkyl. In a first most preferred embodiment R¹ is hydrogen, R² is hydrogen and R³ is methyl (2-methylimidazole).

In a second most preferred embodiment R¹ is hydrogen, R² is methyl and R³ is ethyl (2-ethyl-4-methylimidazole).

Most particularly preferably the sole used imidazole of formula (I) is 2-ethyl-4-methylimidazole, either:
if homogeneously admixed to the liquid epoxy resin formulation, in an amount m_{acc} of 2.5 to 3.5% by weight, based on the liquid epoxy resin formulation; or,
if included into the mica tape, in an amount m_{acc}, of 2.5 to 3.5 grams per square meter of the mica tape.

Imidazoles of formula (I), wherein R¹ and R² do not form together the group —C(R⁴)═C(R⁵)—C(C⁶)═C(R⁷)—, are customarily obtainable e.g. by reaction of a diketone with ammonia and then with an aldehyde according to the well-known Debus-Radziszewski reaction scheme:

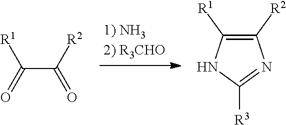

wherein R¹, R² and R³ have the same meanings as in formula (I)

The imidazole of formula (I) may be used, or be present in the mica tape, in the form of a salt. This may refer firstly to an acid addition salt, preferably formed from a C₈-C₂₂ fatty acid or another organic acid having a sufficiently large hydrocarbon residue attached to the carboxyl group. Alternatively it may refer to an acid addition salt formed from any inorganic or organic acid, but wherein the original anion of the acid is subsequently ion-exchanged by another, weakly coordinating anion. Examples of such weakly coordinating anions are tetrafluoroborate, hexafluorophosphate, perchlorate and tetraphenyl borate. In either of these preferred embodiments the solubility of the imidazole salt in the VPI impregnation bath may be low at room temperature but markedly during the VPI curing step at the VPI curing temperature, thus contributing to the “latency” of the imidazole accelerator.

Preferably, the imidazole compound of formula (I) is 2-ethyl-4-methylimidazole, 2-methylimidazole or a salt thereof. Most preferably it is 2-ethyl-4-methylimidazole or a salt thereof, most particularly preferably either

For the purposes of this invention the term mica paper is used in its usual sense to refer to a sheet-like aggregate of mica particles, in particular muscovite or phlogopite particles, which are optionally heated to a temperature of about 550 to about 850° C. for a certain time period (e.g. about 5 minutes to 1 hour) to partially dehydrate them and are ground into fine particles in an aqueous solution and then formed into a mica paper by conventional paper-making techniques. Optionally mica consolidation additives, e.g. dispersing agents, thickening agents, viscosity modifiers and the like as well as resins including inorganic resins such as e.g. boron phosphates or potassium borates and can be added during the formation of the mica paper in order to improve or modify its properties.

The term mica tape as used in this application refers to a sheet-like composite material consisting of one or more layers of mica paper as described above which is (are) glued to a support, i.e. a sheet-like carrier material. The manufacture of mica tapes suitable for the present invention is conventional.

The mica paper is typically impregnated with a solution comprising the imidazole compound of formula (I) or salt thereof as defined above in a suitable low-boiling solvent, such as propylene carbonate (PC), methyl ethyl ketone (MEK), γ-butyro-lactone, methanol or ethanol, or mixtures thereof. Solvents of choice for above mentioned salts of the imidazole compound of formula (I) may be the same and furthermore acetonitrile. The mica paper is contacted with said solution, e.g. by immersion therein or by spraying, and the solvent removed to leave the imidazole compound of formula (I) or salt thereof on and/or inside the structure of the mica paper. The concentration of imidazole compound of formula (I) or salt thereof in the impregnation solution is not critical and can, for instance, vary between e.g. about 0.1 and about 25 percent by weight, subject to the solubility limit of the imidazole compound of formula (I) or salt thereof in the chosen low-boiling solvent. The higher the concentration of imidazole compound of formula (I) or salt thereof in the solution, the higher is the final load of the mica paper achieved during an impregnation step.

The support used in the mica tapes may be a non-metallic inorganic fabric such as glass or alumina fabric or a polymer film such as polyethylene terephthalate or polyimide. Preferably it is a glass cloth or glass fabric of suitable porosity to allow the impregnation resin bath to penetrate into and through the mica tape even if wound in multiple layers atop of each other.

The impregnated mica paper and the support may be adhered together using a small amount (about 1 to about 10 g/m² of mica paper) of a resin, preferably an epoxy resin, an acrylic resin or a polyester resin or a mixture thereof. The agglutination of the mica paper and the support is advantageously performed in a press or a calendar at a temperature above the melting point of the adhesive resin.

The mica tape or the liquid epoxy resin formulation must contain the imidazole compound of formula (I) or salt thereof in an amount sufficient to cure the epoxy resin taken up by the mica paper or mica tape wrapped around the conductor or coil of conductors during the vacuum pressure impregnation step.

It has been found by the inventors that, if the imidazole of formula (I) or salt thereof is used homogeneously admixed to the liquid epoxy resin formulation, then the amount of imidazole of formula (I) or salt thereof (m_{acc}, in grams) to the amount of liquid epoxy resin formulation (mₑₚₒₓ, in grams) should be in the range of 0.02 to 0.10% by weight, based on the liquid epoxy resin formulation:

0.02mₑₚₒₓ≤m_{acc}=≤0.10mₑₚₒₓ (1)

wherein the symbols are as defined above.

It has furthermore been found by the inventors that, if the imidazole of formula (I) or salt thereof is used in the mica tape, then the imidazole of formula (I) or salt thereof should be absorbed onto or impregnated into the mica tape in an amount of 2 to 10 g per square meter of mica tape. This amount m_{acc} (in grams) thus depends on the surface A (in square meters) of the used mica tape and is accordingly in the range:

$$A \times \frac{2 g}{{m}^{2}} \leq {m}_{acc} \leq A \times \frac{10 g}{{m}^{2}} \qquad ( 2 )$$

The “amount of liquid epoxy resin formulation mₑₚₒₓ” is preferably interpreted such as to mean the amount of liquid epoxy resin formulation that is impregnated into the mica tape or otherwise present on the mica tape wrapped around the conductor or around the coil; after having been taken out of the impregnation bath, after dripping off/stripping of excess liquid epoxy resin formulation, and before being cured in the VPI process. This amount of liquid epoxy resin formulation taken up by the mica tape and the conductor or coil of conductors wrapped with during the vacuum pressure impregnation step depends on the nature of the liquid epoxy resin formulation and the shape of the conductor or coil of conductors. Suitable amounts can be determined by a skilled person with a few pilot tests. However the amount mₑₚₒₓ impregnated into the mica tape or otherwise present on the mica tape wrapped around the conductor or around the coil; after having been taken out of the impregnation bath, after dripping off/stripping of excess liquid epoxy resin formulation, and before being cured in the VPI process, is normally and preferably in the range:

$$A \times \frac{100 g}{{m}^{2}} \leq {m}_{epox} \leq A \times \frac{500 g}{{m}^{2}} \qquad ( 3 )$$

wherein all symbols are as defined above. In this preferred interpretation of mₑₚₒₓ, and if mₑₚₒₓ so interpreted and the area A of the used mica tape are according to (3), then the above two ranges (1) and (2) overlap. Namely, in the case of overlap of the two ranges the lower boundary of the range (1) is greater than or equal to the lower boundary of range (2) but smaller than the upper boundary of the range (2):

$$\begin{matrix}0.02 {m}_{epox} \geq A \times \frac{2 g}{{m}^{2}} -> {m}_{epox} \geq A \times \frac{100 g}{{m}^{2}} & ( 4 a ) \\ 0.02 {m}_{epox} \leq A \times \frac{10 g}{{m}^{2}} -> {m}_{epox} \geq A \times \frac{500 g}{{m}^{2}} & ( 4 b )\end{matrix}$$

On the other hand, in the case of overlap of the two ranges (1) and (2) the upper boundary of the range (1) is greater than or equal to the upper boundary of the range (2):

$${m}_{epox} \geq A \times \frac{10 g}{{m}^{2}} -> {m}_{epox} \geq A \times \frac{100 g}{{m}^{2}} \qquad ( 4 c )$$

The right sides of (4a), (4b) and (4c) are equivalent to the above range (3).

In the case of overlap of the two ranges (1) and (2) it is possible to cite one single continuous range for the amount of accelerator m_{acc}:

$$A \times \frac{2 g}{{m}^{2}} \leq {m}_{acc} \leq 0.10 {m}_{epox} \qquad ( 5 )$$

which range holds under the assumptions that mₑₚₒₓ is interpreted as outlined above and is related to the surface A of the used mica tape according to range (3).

If the imidazole of formula (I) is homogeneously admixed to the liquid epoxy resin formulation, then its amount m_{acc} is preferably in the range

mₑₚₒₓ≤m_{acc}≤0.05mₑₚₒₓ (6a)

and more preferably in the range

0.02mₑₚₒₓ≤m_{acc}≤0.03mₑₚₒₓ (6b)

If the imidazole of formula (I) is impregnated into the mica tape (more precisely into the mica paper comprised in the mica tape), then its amount m_{acc} is preferably in the range

$$A \times \frac{2 g}{{m}^{2}} \leq {m}_{acc} \leq A \times \frac{5 g}{{m}^{2}} \qquad ( 7 a )$$

and more preferably in the range

$$A \times \frac{2.5 g}{{m}^{2}} \leq {m}_{acc} \leq A \times \frac{3 g}{{m}^{2}} \qquad ( 7 b )$$

If the amount of liquid epoxy resin formulation mₑₚₒₓ is again interpreted such as to mean the amount of liquid epoxy resin formulation that is impregnated into the mica tape or otherwise present on the mica tape wrapped around the conductor or around the coil; after having been taken out of the impregnation bath, after dripping off/stripping of excess liquid epoxy resin formulation, and assuming the so construed mₑₚₒₓ as being within the range (3), then the above preferred ranges (6a), (6b), (7a) and (7b) are all within the above preferred continuous range (5).

The term “liquid” as used herein, refers to an epoxy resin having a viscosity of at the most 140 mPa·s at 60° C. The term “liquid” preferably simultaneously means that the viscosity the epoxy resin at room temperature is at the most 1000 mPa·s.

The liquid epoxy resin formulation may in principle comprise, further to the at least 80% by weight of bisphenol A diglycidyl ether, any other polyepoxy compound which is liquid in the foregoing sense, in preferred amounts of up to 5 wt %, based on the liquid epoxy resin formulation. These polyepoxy compounds thus act as reactive diluents.

Illustrative examples of suitable polyepoxy compounds are:

A) Polyglycidyl ethers derived from epichlorohydrin and phenolic compounds other than bisphenol A and bisphenol F, such as mononuclear phenols, typically resorcinol or hydroquinone, 2,2-bis(3,5-dibromo-4-hydroxyphenyl)propane, as well as from novolacs obtainable by condensation of aldehydes such as formaldehyde, acetaldehyde, chloral or furfuraldehyde, with phenols such as preferably phenol or cresol, or with phenols which are substituted in the nucleus by chlorine atoms or C₁-C₉alkyl groups, for example 4-chlorophenol, 2-methylphenol or 4-tert-butylphenol.

B) Diglycidylethers derived from epichlorohydrin and acyclic alcohols, typically from ethylene glycol, diethylene glycol and higher poly(oxyethylene) glycols, 1,2-propanediol or poly(oxypropylene) glycols, 1,3-propanediol, 1,4-butanediol, poly(oxytetramethylene) glycols, 1,5-pentanediol, 1,6-hexanediol, 2,4,6-hexanetriol, glycerol, 1,1,1-trimethylolpropane, pentaerythritol, sorbitol, as well as from polyepichlorohydrins. They may also be derived from cycloaliphatic alcohols such as 1,3- or 1,4-dihydroxycyclohexane, 1,4-cyclohexanedimethanol, bis(4-hydroxycyclohexyl)methane, 2,2-bis(4-hydroxycyclohexyl) propane or 1,1-bis(hydroxymethyl)cyclohex-3-ene, or they contain aromatic nuclei such as N,N-bis(2-hydroxyethyl)aniline or p,p′-bis(2-hydroxy-ethylamino)diphenylmethane.

C) Cycloaliphatic epoxy resins comprising at least two oxirane rings fused to a cycloaliphatic ring in the molecule of the epoxy. Preferred examples include resins like e.g diepoxides of dicyclohexadiene or dicyclopentadiene, bis(2,3-epoxycyclopentyl) ether, 1,2-bis(2,3-epoxycyclopentyloxy)ethane, 3,4-epoxycyclohexyl-3′,4′-epoxycyclohexanecarboxylate and 3,4-epoxycyclohexylmethyl-3′,4′-epoxycyclohexanecarboxylate (commercially available as ARALDITE®CY 179-1 from Huntsman, Switzerland).

In one particularly preferred embodiment the liquid epoxy resin formulation for the vacuum pressure impregnation (B) comprises, or consists essentially of, diglycidyl ethers of bisphenol A having the formula:

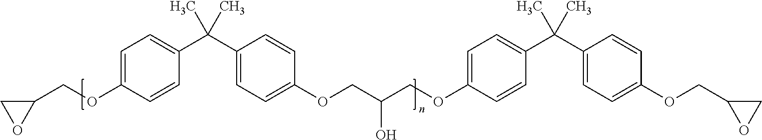

wherein n is a number equal or greater than zero, in particular 0 to 0.3, and represents an average over all molecules. The lower the index n is, the lower is the viscosity of the resin. For the purposes of the present invention at least n is therefore preferably equal to zero or substantially equal to zero, e.g. in the range of 0 to 0.3 corresponding to about 5.85 epoxy equivalents per kg bisphenol A diglycidyl ether resin to about 4.8 epoxy equivalents per kg bisphenol A diglycidyl ether resin. If m is equal to zero or substantially equal to zero, e.g. in the range of 0 to 0.3, then this corresponds to about 6.4 epoxy equivalents per kg bisphenol A diglycidyl ether resin to about 5.3 epoxy equivalents per kg bisphenol A diglycidyl ether resin.

Diglycidyl ethers of bisphenol A with said index n=0 to 0.3 are obtainable by distillation of corresponding raw diglycidyl ethers. The distilled diglycidylethers of bisphenol A furthermore comprise generally a reduced quantity of other side products and/or impurities and have therefore normally an improved shelflife.

In another particularly preferred embodiment the liquid epoxy resin formulation comprises diglycidyl ethers of bisphenol A of the above formula, but wherein n may also be significantly greater than zero, such as 0.3 to 1.5. This corresponds to a mixture of diglycidyl ethers of bisphenol A having n=0 to 1.5, containing significant amounts of higher homologues, besides the lowest homologue with n=exactly zero.

In another particularly preferred embodiment the liquid epoxy resin formulation for the vacuum pressure impregnation (B) comprises, further to diglycidyl ethers of bisphenol A as described immediately above, 0 to 20% by weight, preferably 0 to 10% by weight, based on the liquid epoxy resin formulation, of diglycidyl ethers of bisphenol F having the formula:

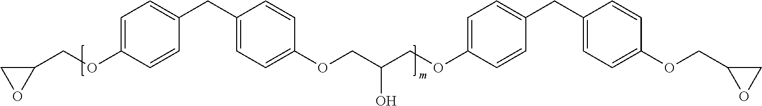

wherein m may be 0 to 0.3, but may also be higher, such as 0.3 to 0.5, and represents an average over all molecules.

The liquid epoxy resin formulation a) in the insulation systems according to the present invention provides, on one hand, a very low viscosity at room temperature or moderately elevated temperatures of about 20° C. to about 60° C. and result, on the other hand, when thermally cured with an imidazole compound of formula (I) or salt thereof, either homogeneously admixed or comprised in the above described mica tape, in a cured insulation material of insulation class F or possibly even H, i.e. permits a maximum continuous use temperature of 155° C. or possibly of 180° C., respectively, which insulation material furthermore exhibits excellent dielectric dissipation factors (tan δ) being at or around 10% at 155° C.

The liquid epoxy resin formulation a) in the inventive insulation systems may optionally furthermore comprise additives for improving the properties of the thermally curable epoxy bath formulation and/or the cured insulation material derived therefrom, such as tougheners or aids for improving the thermal conductivity of the cured insulation material such as micro and/or nano particles selected from the group consisting of metal or semi-metal oxides, carbides or nitrides and wetting agents therefore, as long as these agents are used in amounts that do not have a negative impact on the properties of the epoxy bath formulation before cure, like e.g. on its shelflife or viscosity, and/or on essential properties of the finally obtained cured insulation material, in particular on its dielectric dissipation factor and on its thermal classification.

Suitable tougheners for the purposes of the present invention include e.g. reactive liquid rubbers such as liquid amine- or carboxyl-terminated butadiene acrylonitrile rubbers, dispersions of core-shell rubbers in low viscosity epoxy resins as commercially available e. g. under the tradename Kane Ace™ MX.

Suitable metal or semi-metal oxides, carbides or nitrides include e.g. aluminum oxide (Al₂O₃), titanium dioxide (TiO₂), zinc oxide (ZnO), cerium oxide (CeO₂), silica (SiO₂), boron carbide (B₄C), silicon carbide (SiC), aluminium nitride (AlN) and boron nitride (BN) including cubic boron nitride (c-BN) and particularly hexagonal boron nitride (h-BN), which may optionally be surface-modified in a known way, e.g. by treatment with γ-glycidyloxypropyltrimethoxysilane, to improve the interface and adhesion between the filler and the epoxy matrix. Mixtures of metal, semi-metal oxides, carbides and/or nitrides can of course also be used.

Particularly preferred are metal and semi-metal nitrides, in particular aluminium nitride (AlN) and boron nitride (BN), in particular hexagonal boron nitride (h-BN).

Micro particles are understood for the purposes of this application to include particles of an average particle size of about 1 μm or more, provided that the filler particles can still penetrate the mica tape and the gaps and voids of the construction part to be impregnated.

Preferably the micro particles have a so-called volume diameter D(v)50 of up to about 10 μm, more preferably from about 0.1 to about 5 μm, in particular about 0.1 to about 3 μm, e.g. about 0.5 to 1 μm, wherein a volume diameter D(v)50 of x μm specifies a filler sample wherein 50% of the volume of its particles have a particle size of equal or less than x μm and 50% a particle size of more than x μm. D(v)50 values can e.g. be determined by laser diffractometry.

Micro particles, in particular when present for improvement of the thermal conductivity of the insulation material, are preferably added in amounts of 2 to about 60% by weight based on the total weight of the thermally curable epoxy resin formulation according to the invention, more preferably in amounts of about 5 to about 40% by weight, in particular about 5 to about 20% by weight.

Nano particles are understood for the purposes of this application to include particles of an average particle size of about 100 nm or less, Preferably the nano particles have a volume diameter D(v)50 of up to about 10 to about 75 nm, more preferably from about 10 to about 50 nm, in particular about 15 to about 25 nm, e.g. about 20 nm.

Nano particles are typically used in smaller quantities than micro particles, because in larger amounts they sometimes tend to raise the bath viscosity more than a similar amount of microparticles. Suitable amounts of nano particles preferably range from about 1 up to about 40% by weight based on the total weight of the thermally curable epoxy resin formulation according to the invention, more preferably from about 5 to about 20% by weight, in particular from about 5 to about 15% by weight.

Micro and nano particles can also be used together in admixture.

Preferably, micro and nano particles are surface modified to make them more compatible with the epoxy resins, e.g. surface-treated with γ-glycidyloxypropyltrimethoxysilane, or are used in combination with a wetting agent for said purpose.

Wetting agents are chemical substances that increase the spreading and penetrating properties of a liquid by lowering its surface tension—that is, the tendency of its molecules to adhere to each other at the surface. The surface tension of a liquid is the tendency of the molecules to bond together, and is determined by the strength of the bonds or attraction between the liquid molecules. A wetting agent stretches theses bonds and decreases the tendency of molecules to bond together, which allows the liquid to spread more easily across any solid surface. Wetting agents can be made up of a variety of chemicals, all of which have this tension-lowering effect. Wetting agents are also known as surface active agents (surfactants).

Suitable wetting agents for the purposes of the present application include for example:
acid esters or their salts of alkylene oxide adducts, typically acid esters or their salts of a polyadduct of 4 to 40 mol of ethylene oxide with 1 mol of a phenol, or phosphated polyadducts of 6 to 30 mol of ethylene oxide with 1 mol of 4-nonylphenol, 1 mol of dinonylphenol or, preferably, with 1 mol of compounds which are prepared by addition of 1 to 3 mol of unsubstituted or substituted styrenes to 1 mol of phenol,
polystyrene sulfonates,
fatty acid taurides,
alkylated diphenyl oxide mono- or disulfonates,
sulfonates of polycarboxylates,
the polyadducts of 1 to 60 mol of ethylene oxide and/or propylene oxide with fatty amines, fatty acids or fatty alcohols, each containing 8 to 22 carbon atoms in the alkyl chain, with alkylphenols containing 4 to 16 carbon atoms in the alkyl chain, or with trihydric to hexahydric alkanols containing 3 to 6 carbon atoms, which polyadducts are converted into an acid ester with an organic dicarboxylic acid or with an inorganic polybasic acid,
ligninsulfonates, and
formaldehyde condensates such as condensates of ligninsulfonates and/or phenol and formaldehyde, condensates of formaldehyde with aromatic sulfonic acids, typically condensates of ditolyl ether sulfonates and formaldehyde, condensates of naphthalenesulfonic acid and/or naphthol- or naphthylaminesulfonic acids with formaldehyde, condensates of phenolsulfonic acids and/or sulfonated dihydroxydiphenyl-sulfone and phenols or cresols with formaldehyde and/or urea, as well as condensates of diphenyl oxide-disulfonic acid derivatives with formaldehyde.

There are four main types of wetting agents: anionic, cationic, amphoteric, and nonionic. Anionic, cationic, and amphoteric wetting agents ionize when mixed with water. Anions have a negative charge, while cations have a positive charge. Amphoteric wetting agents can act as either anions or cations, depending on the acidity of the solution. Nonionic wetting agents do not ionize in water.

The wetting agent is generally used in amounts of about 0.05 to about 1% by weight based on the entire impregnation resin composition inclusive the solvent therein, preferably in amounts of about 0.075 to about 0.75% by weight, more preferably in amounts of about 0.1 to about 0.5% by weight, e.g. 0.1 to 0.2% by weight.

Particularly preferred wetting agents include alkyl or, more preferably, alkenyl (ether) phosphates, which are anionic surfactants usually prepared by reaction of primary alcohols or ethylene oxide adducts thereof with phosphorus pentoxide and have the formula:

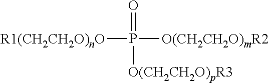

wherein R1 is a linear or branched alkyl or alkenyl group containing 4 to 22, preferably 12 to 18 carbon atoms, and R2 and R3 independently represent hydrogen or R1 and m, n and p are each 0 or a number of 1 to 10. Typical examples are phosphoric acid esters in which the alcohol component is derived from butanol, isobutanol, tert-butanol, caproic alcohol, caprylic alcohol, 2-ethylhexyl alcohol, capric alcohol, lauryl alcohol, isotridecyl alcohol, myristyl alcohol, cetyl alcohol, palmoleyl alcohol, stearyl alcohol, isostearyl alcohol, oleyl alcohol, elaidyl alcohol, petroselinyl alcohol, linolyl alcohol, linolenyl alcohol, elaeostearyl alcohol, arachyl alcohol, gadoleyl alcohol, behenyl alcoho, erucyl alcohol, brassidyl alcohol or mixtures thereof. Similarly, alkyl ether phosphates can be used, which are derived from adducts of an average of 1 to 10 moles of ethylene oxide with the aforementioned alcohols. Preferably mono- and/or dialkyl phosphates can be used based on technical coconut alcohol fractions containing 8 to 18 or 12 to 14 carbon atoms. Wetting agents of this type are known to those skilled in the art and are e.g. described in DE 197 19 606 A1 and partially commercially available.

A further group of wetting agents, preferred in the same way as the aforementioned alkyl or alkenyl (ether) phosphates are reaction products of phosphoric acid or polyphosphoric acids with polyethyleneglycol mono(C₁₋₄alkyl)ether, in particular polyethyleneglycol monomethylether, and cyclic lactones like the (poly)phosphate esters of block copolymers of the following formula:

RO(C₂H₄O)ₘ(PES)ₙ—H

wherein R is C₁₋₄alkyl,
PES is a polyester derived from a cyclic lactone;
m is from about 5 to about 60;
n is from about 2 to about 30;
R may be linear or branched but is preferably linear and especially methyl.

Suitable cyclic lactones include α-acetolactone, β-propiolactone, γ-butyrolactone, γ-valerolactone and, preferably, δ-valerolactone and ε-caprolactone (2-oxepanone), which is most preferred, in which cases PES is composed from repeating units of the following formulae:

—O—CH₂—C(═O)—; —O—(CH₂)₂—C(═O)—; —O—(CH₂)₃—C(═O)—; —O—CH(CH₃)—(CH₂)₃—C(═O)— —O—(CH₂)₄—C(═O)— and —O—(CH₂)₅—C(═O)—.

Preferably m is not greater than 40, more preferably not greater than 25, and n not greater than 20, more preferably not greater than 10, in the block copolymers of formula RO(C₂H₄O)ₘ(PES)ₙ—H, and the ratio of m:n is preferably not less than 3:1, more preferably not less than 4:1, most preferably not less than 6:1.

The molecular weight MW of the block copolymers of formula RO(C₂H₄O)ₘ(PES)ₙ—H is preferably less than 5000, more preferably less than 4000, even more preferably less than 3500 and most preferably less than 3000.

Wetting agents of this type are e.g. described in U.S. Pat. No. 6,133,366 A, US 2011/0244245 A1 or U.S. Pat. No. 5,130,463, the entire description of which is incorporated into the present description by reference including the disclosed preferences. Wetting agents of this type are also commercially available, e.g. under the tradenames like Byk®W 996, Byk®W 9010 or Byk®W 980 and so on.

In a particularly preferred embodiment of the insulation systems according to the invention the thermally curable epoxy bath formulation (B) comprises micro particles, nano particles or a mixture thereof, preferably nano particles, which particles are selected from metal or semi-metal oxides, carbides or nitrides, in particular from metal or semi-metal carbides or nitrides and, optionally, a wetting agent, in particular one of formula:

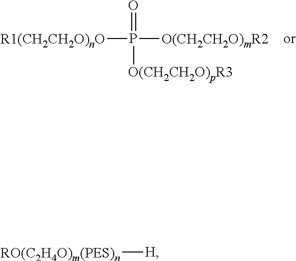

as described above.

The inventive insulation system is preferably, entirely free of other latent epoxy curing accelerators not conforming to above formula (I). This includes freedom of prior art accelerators such as Zn-naphthenate, tertiary amines, sulfonium salts, or boron halogenide salts in free or amine-complexed form. “Freedom” from any of these accelerators shall mean for each such accelerator both less than 0.1% by weight-, based on the liquid epoxy resin formulation, and less than 0.1 grams per square meter of mica tape.

The insulation systems according to the invention are particularly suitable for use in the VPI insulation of conductors or coils of conductors of electrical machines, such as transformers or rotors or stators of electrical generators or motors, in particular of large generators or motors. This use is therefore another subject of the invention.

The electrical insulation systems according to the invention can e.g. be used in the in the VPI insulation of conductors or coils of conductors of electrical machines according to processes, comprising the steps of:

(i) Providing an electrical conductor or a coil of electrical conductors.

(ii) Wrapping the electrical conductor or coil of electrical conductors with the mica tape, which may contain the imidazole of formula (I) or salt thereof, or not.

(iii) Inserting the wrapped electrical conductor or wrapped coil of conductors obtained after step (ii) into a container.

(iv) Evacuating the container.

(v) Feeding into the evacuated container the liquid epoxy resin formulation. To this liquid epoxy resin formulation is admixed beforehand the imidazole of formula (I) or salt thereof, if in step (ii) the mica tape was devoid of imidazole of formula (I) or salt thereof. Optionally the feeding of the liquid epoxy resin formulation into the container is done under heating to a temperature sufficiently high such as to reduce the viscosity of the liquid epoxy resin formulation, but sufficiently low as to prevent the imidazole compound of formula (I) or salt thereof from curing the liquid epoxy resin formulation, to allow the liquid epoxy resin formulation to impregnate the mica tape wrapped electrical conductor or wrapped coil of conductors.

(vi) Applying an overpressure to the container to complete said impregnation of mica tape wrapped electrical conductor or wrapped coil of conductors with the liquid epoxy resin formulation. The length of the period of applying the overpressure to the container can be chosen by a skilled person depending e.g. on the viscosity of the liquid epoxy resin formulation, the structure and impregnability (porosity) of the mica tape used, the size and geometry of the wrapped conductor or wrapped coil of conductors, which shall be impregnated, and ranges preferably from 1 to about 6 hours.

(vii) Removing the impregnated wrapped electrical conductor or wrapped coil of conductors from the container. This may be followed by draining and/or stripping of excess liquid epoxy formulation, to obtain an impregnated amount mₑₚₒₓ which, as outlined above, may typically and preferably lie in the range of 100 to 500 grams per square meter of used mica tape.

(viii) Heating the impregnated wrapped electrical conductor or wrapped coil of conductors to a temperature sufficient and for a period of time long enough to cause the imidazole compound of formula (I) or salt thereof to cure the liquid epoxy resin formulation impregnated into the mica tape and into the electrical machine. The curing temperature depends on the liquid epoxy resin formulation applied and the amount and type of imidazole of formula (I) or salt thereof applied and ranges generally from about 60 to about 200° C., preferably from about 80 to about 160° C.

Following this VPI impregnation step, the wrapped conductor or wrapped coil of conductors having the cured impregnation may be inserted into the intended electrical machine, such as a transformator or electrical motor or generator.

In an especially preferred embodiment of the above process for using the insulation systems according to the invention in the manufacture of rotors, stators or construction parts thereof the liquid epoxy resin formulation is fed into the evacuated container from a storage tank and is returned to said storage tank again after removal from the container and is stored in the tank, optionally under cooling, for further use. Before further use the used bath formulation can be replenished with new formulation.

### EXAMPLES

The following Examples serve to illustrate the invention. Unless otherwise indicated, the temperatures are given in degrees Celsius, parts are parts by weight and percentages relate to percent by weight (weight percent). Parts by weight relate to parts by volume in a ratio of kilograms to litres.

(A) Description of Ingredients Used in the Examples:
2,4 EMI: 2-ethyl-4-methyl-imidazole, supplier: BASF, Germany
MY 790-1 CH: distilled bisphenol A diglycidyl ether (BADGE), epoxy eq.: 5.7-5.9 eq./kg, supplier: Huntsman, Switzerland;
PY 306 bisphenol F diglycidyl ether (BFDGE), epoxy eq.: 6.0-6.4 eq./kg, supplier: Huntsman, Switzerland;
GY 250 undistilled BADGE, epoxy eq.: 5.3-5.45 eq/kg, supplier: Huntsman, Switzerland;
DY 023 2,3-Epoxypropyl o-tolylether, reactive diluent, supplier: Huntsman, Switzerland
CY 179-1: bis-(epoxycyclohexyl)-methylcarboxylate, supplier: Huntsman, Switzerland
HY 1102: methylhexahydrophthalic acid anydride (MHHPA), supplier: Huntsman, Switzerland;
XD 4410: one-component epoxy-based VPI-resin based on BADGE, BFDGE and 2,3-epoxypropyl-o-tolylether, contains highly latent accelerator, supplier Huntsman, Switzerland;

Preparation of Mica Tapes According to the Invention and Application Tests Thereof:

A mica paper sheet based on uncalcined mica flakes with an area weight of 160 g/m² was cut into a sheet of rectangular shape of the size 200×100 mm each. For mica paper impregnation a solution of 2,4-EMI) in methyl ethyl ketone (MEK) was prepared which contained 1.65 wt % of 2,4-EMI. The mica sheet was impregnated with 3.3 g of the solution and the solvent was removed in an oven at 120° C. for 3 min. The mica paper sheet thus prepared contained 2.5 g/m²2,4-EMI. Additionally, the mica sheet was impregnated either in the same step or in a second step with a 5% solution of a binder comprising polyol, polyester or modified polyester and/or polyol in MEK. The mica sheet was impregnated with 1.6 g of this solution. The solvent was removed in an oven at 120° C. for 3 min resulting in 4 g/m² of binder (polyol, polyester or a modified polyester and/or polyol) in the mica paper sheet.

The treated mica paper sheet was used in combination with a glass fabric style 792 (23 g/m², 26×15, 5.5 tex/5.5 tex).

In one alternative the glass fabric was previously coated with 6 to 8 g/m² of a polyester, polyol or polyester/polyol resin mixture. The coated glass was laid on top of the treated mica paper sheet and laminated in a moulding device at 130° C. for 30 s to adhere mica paper and glass fabric together. A mica tape was obtained which is designated in the following as M1.

In another alternative the glass fabric, was previously coated with 3 g/m² of an epoxy/acrylic resin mixture. The coated glass fabric was adhered to the mica tape using furthermore a solid epoxy resin having a melting point around 100° C. For this purpose the solid epoxy resin was evenly dispersed on the treated mica paper. Then the glass fabric was laid on top. The specimen was put into a heated press (130° C. for 30 s) to adhere mica paper and glass fabric together. A mica tape was obtained which is designated in the following as M2.

In either of the two alternatives of mica tape the glass fabric and the mica paper stuck firmly together.

The above obtained mica tape specimens M1 and M2, were each cut in half to give two equal 100×100 mm sized samples.

Preparation of 4-Layered Composites with Inventive Mica Tapes and with Reference Mica Tapes and of Inventive Impregnation Resins, and Tests Thereof

The four 100×100 mm samples (2 M1 and 2 M2) were piled atop of each other with alternatingly 1.625 g evenly distributed impregnation resin after each mica tape layer, giving 4-layered mica tape composites with in each case having total resin weight of 6.5 g. This 4-layered composite is designated in the following as M.

Analogously, four 100×100 mm samples of either a Zn naphthenate-containing mica tape (Poroband ME 4020) or of an accelerator-free mica tape (Poroband 0410) were piled atop of each other with alternatingly 1.625 g evenly distributed impregnation resin after each mica tape layer, giving two further 4-layered mica tape reference composites with in each case having total resin weight of 6.5 g. These 4-layered reference composites are designated in the following as Ref-1 and Ref-2.

The impregnation resins used for adhering the four samples together and the designations of the resulting 4-layered composites, as used in the following tests, are indicated in Table 2.

TABLE 2

| | | Impregnation resin (wt % based on total resin) | | | |
|---|---|---|---|---|---|
| | | | | MY 790- | |
| | | | 5% DY 023; | 1CH/HY | |
| | | Pure | 5% GY 250; | 1102/DY | |
| | | MY 790- | balance MY | 9577/DY | |
| | | 1 CH | 790-1 CH | 073 | XD 4410 |
| 4-layered | M | Inv-1 | Inv-2 | | |
| composite | 4 layers | | | Ref-1 | |
| | of | | | [Comp A] | |
| | Poroband | | | | |
| | ME 4020 | | | | |
| | 4 layers | | | | Ref-2 |
| | of | | | | [Comp B] |
| | Poroband | | | | |
| | 0410 | | | | |

For further comparison purposes some anhydride-free impregnation resins were also homogeneously mixed in the absence of mica tape with small amounts of 2,4-EMI and cured in the absence of any mica tapes. The compositions of these further inventive formulations and their designations, as used in the following tests, are indicated in Table 3:

TABLE 3

| | | Impregnation resin (wt % based on total resin) | | | | | |
|---|---|---|---|---|---|---|---|
| | | | 5% DY 023 | | 19.5% | | 8% DY 023 |
| | | | 5% GY 250; | 10% CY 179-1; | PY306; | 5% CY 179-1; | 5% GY 250; |
| | | Pure MY | balance MY | balance MY | balance MY | balance MY | balance MY |
| | | 790-1 CH | 790-1 CH | 790-1 CH | 790-1 CH | 790-1 CH | 790-1 CH |
| Homogeneously | 2.5% | Inv-3 | | Inv-5 | Inv-6 | Inv-7 | Inv-8 |
| added accelerator | 2,4-EMI; | | | [too much | [bis-F | | |
| (wt % based on | | | | cyclo] | instead Bis- | | |
| overall | | | | | A] | | |
| formulation) | 3.0% | | Inv-4 | | | | |
| | 2,4-EMI | | | | | | |

The curing conditions for all samples were as follows:
Inventive composite M (Experiments Inv-1 and Inv-2) and reference composite Comp-B: heating press; 100° C. at 20 bar for 4 h and then increasing the temperature to 170° C. at 20 bar for 10 h.
Reference composite Comp-A: heating press; 160° C. at 20 bar for 12 h.
Inventive homogeneous formulations Inv-3, Inv-4, Inv-5, Inv-6, Inv-7 and Inv-8: heatable mould; 100° C. for 2 h and then increasing the temperature to 160° C. for 10 h;

All cured 4-layered composites and cured inventive formulations were subject to the following tests:
1) Tan δ measurement according to IEC 60250 at 155° C. in Tettex instrument using a guard ring electrode at 400V/50 Hz;
2) Glass transition temperature Tg. For the 4-layered composites according to IEC 61006 via DMA at 5°/min rate, using the temperature at which the maximal tan δ is observed as Tg; on 50 mm×10 mm specimens of the composites. For the reference formulations directly via DSC.

The results of all the above tests are summarised in below Table 4 (for the 4-layered inventive and reference composites) and in below Table 5 (for the inventive homogeneous formulations).

TABLE 4

| | | Ref-1 | Ref-2 | | |
|---|---|---|---|---|---|
| | | [Comp | [Comp | Inv-1 | Inv-2 |
| | | A] | B] | [LME11098] | [LME11179] |
| Test | tan δ | 4.40% | 22.8% | 12% | 17% |
| | Tg (° C.) | 151.4 | 121.8 | 128.4 | 108.8 |

TABLE 5

| | | | | Inv-5 | Inv-6 | | |
|---|---|---|---|---|---|---|---|
| | | Inv-3 | Inv-4 | [too much | [bis-F instead | Inv-7 | Inv-8 |
| | | [LME11098] | [LME11179] | cyclo] | Bis-A] | [LME 11117] | [Bä 3575-2] |
| Test | tan δ | 8.4% | 8.0% | 15.7 | 15 | 9.2 | 9.7 |
| | Tg (° C.) | 186/181 | 154/155 | 160/161 | 173/178 | 157/159 | 161/162 |

Conclusions Based on the Comparisons of Inventive Impregnated Mica Tapes with Reference Mica Tapes and Conclusions Based on Homogeneous Inventive Formulations

Firstly, the inventive systems having 4-layered composite with imidazole accelerator and accelerator-free epoxy resin (Inv-1 resp. Inv-2) cure nearly equally well as the corresponding inventive systems (Inv-3 resp. Inv-4) having impregnation baths with homogeneously admixed accelerator (in these inventive systems the co-used mica-tape would be devoid of imidazole accelerator). This can be derived from the observed Tg values of Table 4, which all are at least about 110° C.

The inventive systems having a 4-layered composite with imidazole accelerator and accelerator-free epoxy resin (Inv-1 and Inv-2) also cure nearly equally well as the prior art system with a 4-layered composite with Zn-naphthenate accelerator (Ref-1). They cure better than the prior art system which is a homogeneous one-component impregnation bath which contains a homogeneously dispersed highly latent curing accelerator together with an accelerator-free mica tape (Ref-2). That the Tg values of the inventive systems with imidazole accelerator in the mica tape (Inv-1, Inv-2) should be lower than the Tg value of the prior art system Ref-1 is of lesser concern. Firstly, the Tg value may be increased in by more stringent curing conditions (higher curing temperature and/or curing time). Secondly, changing from manual fabrication of the tapes (as in the instant examples) to machine production might improve the Tg value. Thirdly, if the inventive tape is used in a VPI-impregnated electrical machine under “Class F” or even “Class H” conditions, then an after-cure and associated increase in Tg is expected to automatically occur by the prolonged elevated use temperatures.

The tan δ values of 17% and 12% of the inventive systems Inv-1 and Inv-2 are already close to the specification of 10% at the most. Further improvement may be possible by improved curing (see above) and by slight variations in the amount ranges of accelerator within the ranges disclosed and by slight variations in the compositions of the first and second binders within the disclosed polymer categories and ranges will be sufficient to achieve the specification.

The homogeneous inventive systems having imidazole accelerator homogeneously admixed to the epoxy resin (to be used with accelerator-free mica tape), Inv-3 to Inv-8, all produce very high Tg values with good tan δ within or just above specification of 10%, making them all suited for Class H use. Specifically the inventive homogeneous system wherein some diglycidyl ether of bisphenol A is replaced by diglycidyl ether of bisphenol F (Inv-6) has the highest Tg value, but with tan δ just above specification of 10%. Use of only about 5-10% by weight of diglycidyl ether of bisphenol F by diglycidyl ether (instead of the 19.5% actually used in Inv-6) is expected to produce inventive homogeneous systems with both high Tg values and tan δ within specification.

Adding small amounts (e.g. 2-10% by weight) of reactive diluents, such as 2,3-epoxypropyl o-tolylether or bis-(epoxycyclohexyl)-methylcarboxylate, and/or addition of small amounts (e.g. 2-10% by weight) of undistilled diglycidly ether of bisphenol A (with n of up to 1.5 in formula (II)) to inventive homogeneous systems (e.g. Inv-3, Inv-8), may improve (lower) the viscosity of inventive homogeneous systems at VPI impregnation temperatures of e.g. 60° and/or prevent crystallisation at room temperature, but does not notably affect the Tg and tan δ values after curing. This is particularly surprising for bis-(epoxycyclohexyl)-methylcarboxylate as such reactive diluent, because bis-(epoxycyclohexyl)-methylcarboxylate as such was observed to be not curable by the imidazole of formula (I).

1. An insulation system, comprising:
(a) an amount mₑₚₒₓ of a liquid epoxy resin formulation comprising at least 80% by weight, based on the liquid epoxy resin bath formulation, of bisphenol A diglycidyl ether,
(b) a mica tape having an area (“A”); and
(c) an amount m_{acc} of an imidazole compound of the formula (I) or an acid salt thereof: 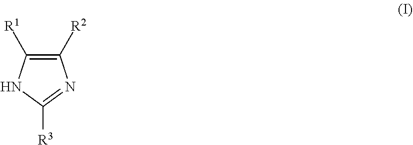
wherein R¹, R² and R³ are individually selected from hydrogen, branched or unbranched C₁-C₄-alkyl, phenyl, and benzyl, provided that at least one of R¹ and R² is hydrogen; and
wherein the amount m_{acc} in the system is in a range of
0.02mₑₚₒₓ≤m_{acc}≤0.10mₑₚₒₓ
or the in a range of
$$A \times \frac{2 grams}{{m}^{2}} \leq {m}_{acc} \leq A \times \frac{10 grams}{{m}^{2}} ;$$
wherein A is in square metres and m_{acc} is in grams.

2. The insulation system according to claim 1, wherein the imidazole compound of formula (I) is 2-ethyl-4-methylimidazole or 2-methylimidazole.

3. The insulation system according to claim 1, wherein the bisphenol A diglycidyl ether in the liquid epoxy resin formulation comprises diglycidylethers of bisphenol A having the formula (II): 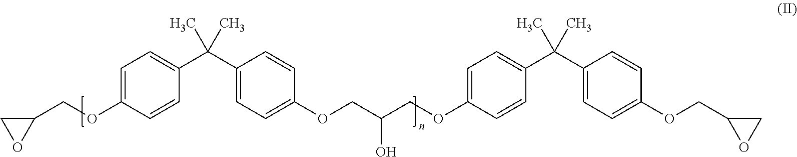
wherein n is a number equal to or greater than zero and represents an average over all molecules of the liquid epoxy resin formulation.

4. The insulation system according to claim 3, wherein the n of formula (II) is in the range of 0 to 0.3.

5. The insulation system according to claim 1, wherein the liquid epoxy resin formulation further comprises 0 to 20% by weight, based on the liquid epoxy resin formulation, of diglycidyl ethers of bisphenol F having the formula: 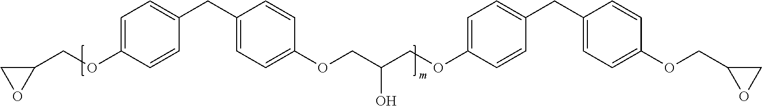
wherein m is 0 to 0.5 and represents an average over all molecules.

6. The insulation system according to claim 1, wherein the liquid epoxy resin formulation further comprises 0 to 5% by weight, based on the liquid epoxy resin formulation, of one or more reactive diluents selected from the group consisting of: polyglycidyl ethers derived from epichlorohydrin and phenolic compounds other than bisphenol A, diglycidylethers derived from epichlorohydrin and acyclic alcohols and cycloaliphatic epoxy resins comprising at least two oxirane rings fused to a cycloaliphatic ring.

7. The insulation system according to claim 3, wherein the liquid epoxy resin formulation further comprises 0 to 5% by weight, based on the liquid epoxy resin formulation, of bis-(epoxycyclohexyl)-methylcarboxylate.

8. The insulation system according to claim 1, wherein the liquid epoxy resin formulation further comprises one or more additives selected from the group consisting of tougheners, micro particles, nano particles and wetting agents.

9. The insulation system according to claim 1, wherein the imidazole compound of formula (I) or salt thereof is homogeneously admixed with the liquid epoxy resin formulation in an amount m_{acc} in the range of
0.02mₑₚₒₓ≤m_{acc}≤0.10mₑₚₒₓ.

10. The insulation system according to claim 9, wherein the imidazole compound of formula (I) is 2-ethyl-4-methylimidazole and is present in an amount ranging from 2.5 to 3.5% by weight, based on the liquid epoxy resin formulation.

11. The insulation system according to claim 1, wherein the mica tape comprises a mica paper and a support, and wherein the imidazole compound of formula (I) or salt thereof is impregnated into the mica paper in an amount m_{acc} in a range of
$$A \times \frac{2 grams}{{m}^{2}} \leq {m}_{acc} \leq A \times \frac{10 grams}{{m}^{2}}$$

12. The insulation system according to claim 11, wherein the imidazole compound of formula (I) is 2-ethyl-4-methylimidazole and is present in an amount ranging from 2.5 to 3.5 grams of 2-ethyl-4-methylimidazole per square meter of mica tape.

13. Insulated conductors or coils of conductors of electrical machines comprising the insulation system of claim 1, wherein the insulation system of claim 1 has been cured.

14. A process for producing an insulated electrical conductor or an insulated coil comprising electrical conductors, comprising:
(i) wrapping an electrical conductor or coil of electrical conductors with a mica tape comprising an imidazole compound of formula (I) or salt thereof 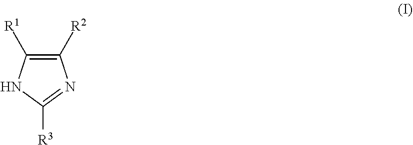
wherein R¹, R² and R³ are individually selected from hydrogen, branched or unbranched C₁-C₄-alkyl, phenyl and benzyl, provided that at least one of R¹ and R² is hydrogen;
(ii) inserting the wrapped electrical conductor or wrapped coil of conductors obtained after step (i) into a container;
(iii) evacuating the container;
(iv) feeding a liquid epoxy resin formulation into the evacuated container, optionally under heating to a temperature sufficiently high such as to reduce the viscosity of the liquid epoxy resin formulation, but sufficiently low as to prevent the imidazole compound of formula (I) or salt thereof from curing the liquid epoxy resin formulation, to allow the liquid epoxy resin formulation to impregnate the mica tape;
(v) applying an overpressure to the container to complete said impregnation of mica tape with the liquid epoxy resin formulation;
(vi) removing the wrapped electrical conductor or wrapped coil of conductors from the container; and
(vii) heating the wrapped electrical conductor or wrapped coil of conductors to a temperature sufficient and for a period of time long enough to cure the liquid epoxy resin formulation impregnated into the wrapped electrical conductor or wrapped coil of conductors.

15. (canceled)

16. The insulation system according to claim 1, wherein the insulation system is substantially free of latent epoxy curing accelerators not conforming to formula (I).
